(19) United States
(12) Patent Application Publication
(10) Pub. No.: US 2022/0181738 A1
(43) Pub. Date: Jun. 9, 2022

(54) BATTERY CASE STRUCTURE

(71) Applicant: Honda Motor Co., Ltd., Tokyo (JP)

(72) Inventors: Ken YASUI, Saitama (JP); Masaya KUROIWA, Saitama (JP); Shutaro SAO, Tokyo (JP)

(73) Assignee: Honda Motor Co., Ltd., Tokyo (JP)

(21) Appl. No.: 17/544,884

(22) Filed: Dec. 7, 2021

(30) Foreign Application Priority Data
Dec. 9, 2020 (JP) 2020-203972

(51) Int. Cl. H01M 50/249; H01M 50/209; H01M 50/224

(52) U.S. Cl. CPC H01M 50/249; H01M 2220/20; H01M 50/224; H01M 50/209

(57) ABSTRACT

The disclosure provides a battery case structure. The battery case structure includes a battery provided below a floor panel of a vehicle, a lower case covering the battery from below, and an upper case including a horizontal plate portion arranged between the floor panel and the battery and covering the battery from above. The thickness of the outer peripheral portion of the horizontal plate portion in the upper case along the vertical direction is thicker than the thickness of the inner peripheral portion of the horizontal plate portion along the vertical direction. The upper case is formed in a plate shape by a metal material, and a plate-shaped reinforcing member is attached to the outer peripheral portion.

### CROSS-REFERENCE TO RELATED APPLICATION

This application claims the priority benefits of Japanese application no. 2020-203972, filed on Dec. 9, 2020. The entry of the above-mentioned patent application is incorporated by reference herein and made a part of the specification.

### BACKGROUND

### Technical Field

The disclosure relates to a battery case structure.

### Description of Selected Art

Conventionally, there is known a battery case structure in which a battery is arranged at the bottom of an automobile and a battery case is provided so as to cover the battery. In these battery case structures, for example, various techniques for improving impact resistance and heat resistance have been proposed.

For example, Patent Literature 1 discloses a tray component arranged below a battery, in which the tray component has an upper plate portion, a middle plate portion, and a lower plate portion. A cooling cavity is provided between the upper plate portion and the middle plate portion, and a buffer cavity is provided between the middle plate portion and the lower plate portion. According to the technique described in Patent Literature 1, by arranging the heat insulating material in the buffer cavity, the impact from below can be reduced and the thermal influence on the battery can be reduced.

### RELATED ART

### Patent Literature

[Patent Literature 1] Japanese Patent Application Laid-Open No. 2019-531955

However, the technique described in Patent Literature 1 has not taken into account the heat insulating property between the battery and a member (e.g. the floor panel) arranged on the upper part of the battery. Therefore, when exposed to a situation where the road surface is burning due to an accident the like, there is a problem in improving the heat resistance of the floor panel, vehicle compartments, and the like located above the battery while protecting the battery, for example. To solve such a problem, for example, arranging a case member on the upper part of the battery has been considered. However, if the plate thickness of the case member is increased to ensure sufficient heat resistance, the weight could increase.

Therefore, an object of the disclosure is to provide a battery case structure having improved heat resistance while suppressing an increase in weight.

### SUMMARY

In order to solve the above problem, the disclosure according to technical solution 1 recites a battery case structure (e.g. a battery case structure 1 of the first embodiment) which includes a battery (e.g. batteries 2 of the first embodiment) provided below a floor panel (e.g. a floor panel 8 of the first embodiment) of a vehicle (e.g. a vehicle 10 of the first embodiment), a lower case (e.g. a lower case 3 of the first embodiment) covering the battery from below, and an upper case (e.g. an upper case 4 of the first embodiment) having an upper surface portion (e.g. a horizontal plate portion 11 of the first embodiment) arranged between the floor panel and the battery and covering the battery from above, in which a thickness (e.g. a thickness t2 of the first embodiment) of an outer peripheral portion (e.g. an outer peripheral portion 20 of the first embodiment) of the upper surface portion of the upper case along the vertical direction is thicker than a thickness (e.g. a thickness t1 of the first embodiment) of an inner peripheral portion (e.g. an inner peripheral portion 30 of the first embodiment) of the upper surface portion along the vertical direction.

### BRIEF DESCRIPTION OF THE DRAWINGS

FIG. 1 is a side view of a vehicle equipped with a battery case structure according to the first embodiment.

FIG. 2 is an enlarged view of part II of FIG. 1.

FIG. 3 is an external perspective view of a battery case structure according to a first embodiment.

FIG. 4 is a cross-sectional view of an upper case taken along line IV-IV of FIG. 3.

FIG. 5 is a plan view of an upper case showing a temperature distribution in the upper case.

FIG. 6 is a plan view of an upper case according to a second embodiment.

FIG. 7 is a plan view of an upper case according to a third embodiment.

FIG. 8 is a cross-sectional view of an upper case according to a fourth embodiment.

### DESCRIPTION OF THE EMBODIMENTS

Hereinafter, embodiments of the disclosure will be described with reference to the drawings. In the drawings, an arrow FR indicates the front side of the vehicle, an arrow UP indicates the upper side of the vehicle, and an arrow LH indicates the left side of the vehicle. Further, a battery case structure 1 has a substantially symmetrical structure. Therefore, hereinafter, the same reference numerals will be given to the left and right structural members, the left structural member will be described in detail, and the detailed description of the right structural member will be omitted.

### First Embodiment

(Battery Case Structure)

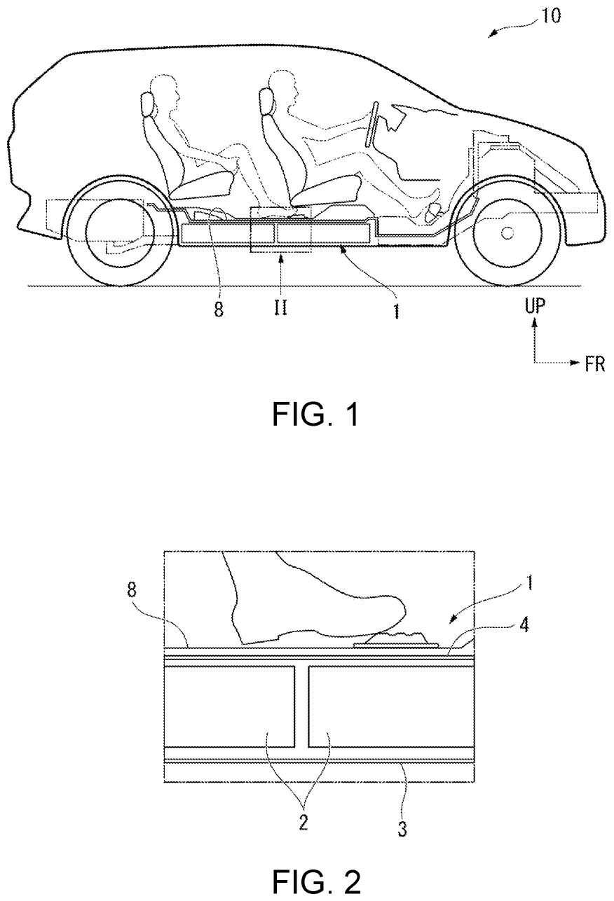

FIG. 1 is a side view of a vehicle 10 equipped with the battery case structure 1 according to the first embodiment. FIG. 2 is an enlarged view of part II of FIG. 1.

As shown in FIG. 1 and FIG. 2, the battery case structure 1 is arranged at the lower portion of the vehicle 10. The battery case structure 1 constitutes a lower structure of the vehicle 10. Specifically, the lower structure of the vehicle 10 includes a side sill unit (not shown), a floor panel 8, a cross member unit (not shown), and the battery case structure 1.

The side sill unit (not shown) includes a pair of left and right side sills. Each side sill is a highly rigid member formed in a closed cross section and constituting the frame of the vehicle 10. The left side sill is arranged on the outer side of the left side in the vehicle width direction, and extends in the front-rear direction along the outer side of the floor panel 8 in the vehicle width direction. The right side sill is arranged on the outer side of the right side in the vehicle width direction, and extends in the front-rear direction along the outer side of the floor panel 8 in the vehicle width direction.

The floor panel 8 is provided between the pair of left and right side sills (not shown). The floor panel 8 is a plate-shaped member having a substantially rectangular shape in a plan view, and forms the floor portion of the vehicle 10. The floor panel 8 is formed substantially horizontally. A floor tunnel (not shown) is provided at the center of the floor panel 8 in the vehicle width direction. The floor tunnel rises upward from the floor panel 8 in a U-shaped cross section and extends in the front-rear direction.

A cross member unit (not shown) is provided between the left and right side sills. The cross member unit has a plurality of cross members. In the present embodiment, two cross members are provided on the left side and two on the right side of the floor tunnel. Since the left and right cross members have the same configuration, the left cross member will be described below.

The cross members on the left side extend along the width direction between the side sill on the left side and the floor tunnel. The two cross members are arranged substantially parallel to each other with a space in the front-rear direction. Each cross member is formed so as to be convex upward from the floor panel 8. An upper surface of the cross member is formed substantially horizontally, similar to the floor panel 8. An inner end of the cross member located on the inner side in the vehicle width direction is joined to the floor tunnel by spot welding. An outer end of the cross member located on the outer side in the vehicle width direction is joined to the side sill by spot welding.

The battery case structure 1 is provided below the floor panel 8. The battery case structure 1 includes batteries 2, an upper case 4, and a lower case 3. The batteries 2 are housed in the space surrounded by the upper case 4 and the lower case 3.

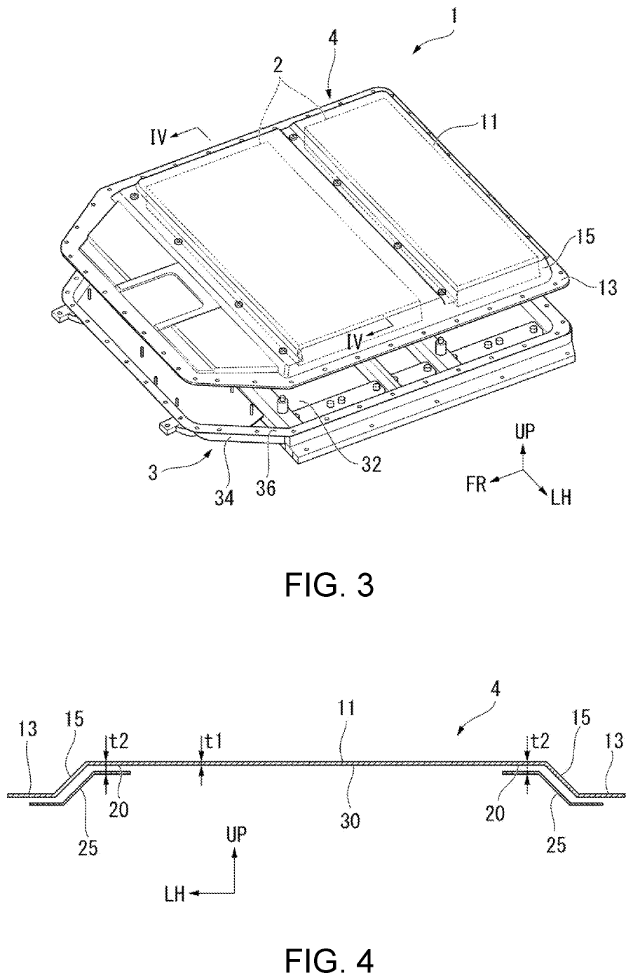

In the present embodiment, a plurality of batteries 2 are provided side by side in the front-rear direction (see also FIG. 3). The batteries 2 are formed in a rectangular shape in a plan view. Similar to the floor panel 8, the batteries 2 are arranged substantially horizontally. The batteries 2 is, for example, a nickel hydrogen battery, a lithium ion battery, or the like. In the space between the upper case 4 and the lower case 3, in addition to the batteries 2, a power control unit (PCU) configured by an inverter, a DC/DC converter, a motor ECU, a cooling fan, and the like may be accommodated.

FIG. 3 is an external perspective view of the battery case structure 1 according to the first embodiment. FIG. 4 is a cross-sectional view of the upper case 4 taken along line IV-IV of FIG. 3.

As shown in FIG. 3, the upper case 4 covers the plurality of batteries 2 from above. The upper case 4 is formed in a polygonal shape that is one size larger in a plan view than an area in which the plurality of batteries 2 are combined. As shown in FIG. 3 and FIG. 4, the upper case 4 is formed in a plate shape by, for example, pressing a metal plate material. From the viewpoint of weight reduction, it is more desirable to use an aluminum alloy as the material of the upper case 4.

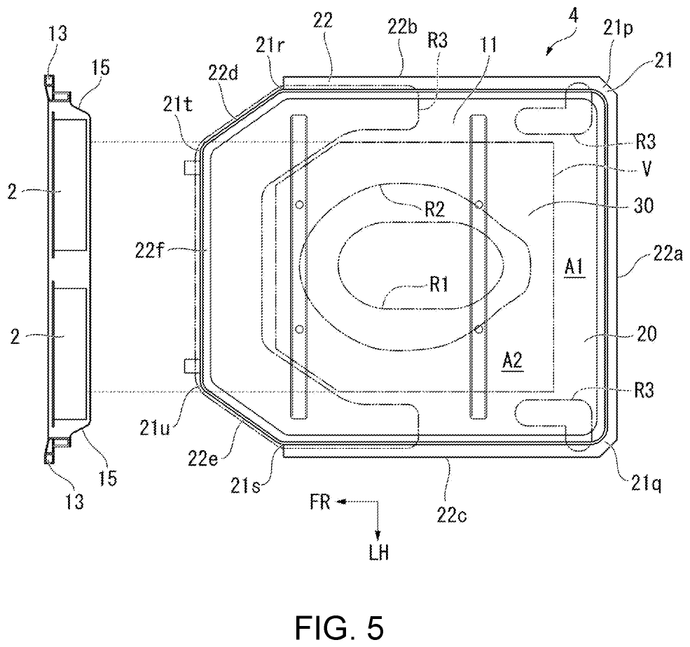

FIG. 5 is a plan view of the upper case 4 showing a temperature distribution in the upper case 4.

The upper case 4 is formed in a box shape that opens downward. Specifically, the upper case 4 includes a horizontal plate portion 11 (the upper surface portion in the claim), an upper inclined portion 15 (the inclined portion in the claim), an upper flange 13 (the flange in the claim), and a reinforcing member 25 (see FIG. 4).

The horizontal plate portion 11 is formed substantially parallel to the upper surfaces of the batteries 2. The horizontal plate portion 11 is formed in a plate shape with the vertical direction as the thickness direction. The horizontal plate portion 11 is arranged between the floor panel 8 and the batteries 2. As shown in FIG. 5, the horizontal plate portion 11 is formed in a hexagonal shape having a plurality of first to sixth sides 22 in a plan view. A first side 22a extends along the vehicle width direction. A second side 22b extends forward from the right end of the first side 22a along a direction (front-rear direction) orthogonal to the first side 22a. A third side 22c extends forward from the left end portion of the first side 22a along a direction (front-rear direction) orthogonal to the first side 22a. The fourth side 22d extends obliquely to the left and forward from the front end portion of the second side 22b. The fifth side 22e extends obliquely to the right and forward from the front end portion of the third side 22c. A sixth side 22f connects the front end portion of the fourth side 22d and the front end portion of the fifth side 22e, and extends along the vehicle width direction.

First to sixth corner portions 21 are provided between the sides 22, respectively. A first corner portion 21p is provided between the first side 22a and the second side 22b. An angle of the first corner portion 21p is about 90°. A second corner portion 21q is provided between the first side 22a and the third side 22c. An angle of the second corner portion 21q is about 90°. A third corner portion 21r is provided between the second side 22b and the fourth side 22d. An angle of the third corner portion 21r is an obtuse angle. A fourth corner portion 21s is provided between the third side 22c and the fifth side 22e. An angle of the fourth corner portion 21s is an obtuse angle. A fifth corner portion 21t is provided between the fourth side 22d and the sixth side 22f. An angle of the fifth corner portion 21t is an obtuse angle. A sixth corner portion 21u is provided between the fifth side 22e and the sixth side 22f. An angle of the sixth corner portion 21u is an obtuse angle.

As described above, the horizontal plate portion 11 of the upper case 4 is formed in a polygonal shape having a plurality of corner portions 21 in a plan view. Further, the horizontal plate portion 11 has a plurality of linear portions (sides 22) located between adjacent corner portions 21. In the present embodiment, the lengths of the first side 22a, the second side 22b, and the third side 22c are substantially the same. The length of the sixth side 22f is shorter than the length of the first side 22a, the second side 22b, and the third side 22c. The length of the fourth side 22d and the fifth side 22e is shorter than the length of the sixth side 22f. Therefore, in the present embodiment, the fourth side 22d and the fifth side 22e are the shortest linear portions having the shortest length among the first to sixth sides 22.

As shown in FIG. 4 and FIG. 5, the thickness t2 of an outer peripheral portion 20 of the horizontal plate portion 11 along the vertical direction is thicker than the thickness t1 of the inner peripheral portion 30 of the horizontal plate portion 11 along the vertical direction. The horizontal plate portion 11 of the upper case 4 is formed such that the thickness t2 of the outer peripheral portion 20 is thicker than the thickness t1 of the inner peripheral portion 30 by attaching the reinforcing member 25, which will be described in detail, to the outer peripheral portion 20.

As shown in FIG. 3 and FIG. 4, the upper inclined portion 15 is connected to the peripheral edge portion of the horizontal plate portion 11. The upper inclined portion 15 extends downward from the peripheral edge portion of the horizontal plate portion 11. The upper inclined portion 15 extends obliquely so as to be located in a direction away from the horizontal plate portion 11 (outside of the horizontal plate portion 11) in a plan view as it goes downward from the horizontal plate portion 11. The upper inclined portion 15 is provided over the entire periphery of the peripheral edge portion of the horizontal plate portion 11.

The upper flange 13 is provided below the horizontal plate portion 11. The upper flange 13 is connected to a lower end portion of the upper inclined portion 15. Therefore, the upper flange 13 is connected to the horizontal plate portion 11 via the upper inclined portion 15. The upper flange 13 extends from the lower end portion of the upper inclined portion 15 in a direction away from the horizontal plate portion 11 (outside of the horizontal plate portion 11) in a plan view. The upper flange 13 is formed substantially parallel to the horizontal plate portion 11. The upper flange 13 is provided over the entire periphery of the lower end portion of the upper inclined portion 15. The upper flange 13 is in contact with the lower flange 36 of the lower case 3. The upper flange 13 is connected to the lower flange 36 by a fastening member such as a bolt. By connecting the upper flange 13 and the lower flange 36, the upper case 4 and the lower case 3 are connected.

The reinforcing member 25 is made of, for example, the same material as the upper case 4. In the present embodiment, the reinforcing member 25 is a patch formed of an aluminum alloy plate material. The reinforcing member 25 is attached to the outer peripheral portion 20 of the upper case 4. The reinforcing member 25 is formed to follow a surface shape of the upper case 4 by pressing, for example, and then adhered to the upper case 4 by an adhesive. The reinforcing member 25 may be welded to the upper case 4 by, for example, spot welding. As shown in FIG. 4, the reinforcing member 25 is provided from the outer peripheral portion 20 of the horizontal plate portion 11 in the upper case 4, via the upper inclined portion 15 to the upper flange 13. In the present embodiment, the reinforcing member 25 is provided over the entire outer peripheral portion 20 (entire periphery) of the horizontal plate portion 11.

Here, the definitions of the outer peripheral portion 20 and the inner peripheral portion 30 in the horizontal plate portion 11 of the upper case 4 will be described based on test results. In the present embodiment, the case is exposed to a flame with the upper case 4 and the lower case 3 to be described later combined, and a flame test is performed to verify the fire resistance of the case. In the flame test, the upper case 4 and the lower case 3 are exposed to the flame from below in a state of being assembled with each other (the same posture and state as when mounted on the vehicle), and are removed from the flame after a predetermined time elapses. The upper case 4 is required to have heat resistance (fire resistance) to such an extent that damage such as holes or cracks do not occur after the flame test is completed.

Virtual lines R1, R2, and R3 in FIG. 5 are the temperature contour lines of the upper case 4 in the flame test. The high-low relationship of the temperature in the area surrounded by the virtual lines R1, R2, and R3 is R1<R2<R3. As shown in FIG. 5, the temperature of the central portion (the portion surrounded by the virtual line R1) of the horizontal plate portion 11 of the upper case 4 is the lowest. The temperature is highest in the portion located slightly outside the central portion (the portion surrounded by the virtual line R2) has a temperature distribution of about medium to low temperatures. The temperature is highest in the periphery of the peripheral edge of the horizontal plate portion 11, particularly in the U-shaped portion in a plan view extending through four corner portions 21r, 21s, 21t, 21u located in the front and having a close distance to each other and the portions corresponding to the two corner portions 20p and 21q (the portion surrounded by the virtual line R3) in the rear.

Based on this test result, in the horizontal plate portion 11 including a portion surrounded by the virtual line R3 that has the highest temperature. a virtual boundary line V is assumed by connecting portions separated inward by a predetermined length from the peripheral edge portion of the horizontal plate portion 11 with a linear line. The boundary line V is a line that separates the area A1 including the portion surrounded by the virtual line R3 having the highest temperature and the area A2 inside the area A1. In the present embodiment, of the areas separated by the boundary line V, the portion corresponding to the area A1 is referred to as the “the outer peripheral portion 20 of the horizontal plate portion 11”, and the portion corresponding to the area A2 is referred to as the “the inner peripheral portion of the horizontal plate portion 11”. As a result, it is possible to reliably increase the thickness of the portion having the highest temperature in the flame test and suppress the occurrence of damage to the upper case 4.

As shown in FIG. 3, the lower case 3 covers the plurality of batteries 2 from below. The lower case 3 is formed in a polygonal shape having the same size and shape as the upper case 4 in a plan view. The lower case 3 is formed by, for example, pressing a metal plate material. From the viewpoint of weight reduction, it is more desirable to use an aluminum alloy as the material of the lower case 3.

The lower case 3 is formed in a box shape that opens upward. The structure of the lower case 3 is substantially vertically symmetrical with that of the upper case 4. That is, the lower case 3 includes a bottom plate portion 32, a lower inclined portion 34, and a lower flange 36.

The bottom plate portion 32 is formed substantially parallel to the lower surfaces of the batteries 2. The bottom plate portion 32 is formed in a plate shape with the vertical direction as the thickness direction. The bottom plate portion 32 is formed in the same shape as the horizontal plate portion 11 of the upper case 4 in a plan view. The thickness of the bottom plate portion 32 along the vertical direction is constant thickness overall.

The lower inclined portion 34 is connected to the peripheral edge portion of the bottom plate portion 32. The lower inclined portion 34 extends upward from the peripheral edge portion of the bottom plate portion 32. The downward inclined portion 34 extends obliquely so as to be located in a direction away from the bottom plate portion 32 (outside of the bottom plate portion 32) in a plan view as it goes upward from the bottom plate portion 32. The lower inclined portion 34 is provided over the entire periphery of the peripheral edge portion of the bottom plate portion 32.

The lower flange 36 is connected to the upper end of the lower inclined portion 34. The lower flange 36 is connected to the bottom plate portion 32 via the lower inclined portion 34. The lower flange 36 extends from the upper end portion of the lower inclined portion 34 in a direction away from the bottom plate portion 32 (outside of the bottom plate portion 32) in a plan view. The lower flange 36 is formed substantially parallel to the bottom plate portion 32. The lower flange 36 is provided over the entire periphery of the upper end portion of the lower inclined portion 34. The lower flange 36 is in contact with and connected to the upper flange 13 of the upper case 4.

(Function, Effect)

Next, the operation and effect of the above-mentioned battery case structure 1 will be described.

According to the battery case structure 1 of the present embodiment, the upper case 4 is provided between the battery 2 and the floor panel 8. The thickness t2 of the outer peripheral portion 20 of the upper case 4 is thicker than the thickness t1 of the inner peripheral portion 30. Therefore, the heat resistance of the outer peripheral portion 20 which tends to be higher than that of the inner peripheral portion 30 can be enhanced. As a result, the overall heat resistance of the upper case 4 can be improved while keeping the thickness of the inner peripheral portion 30 thin. Since the heat resistance of the upper case 4 can be improved by increasing only the thickness of the outer peripheral portion 20, the weight increase of the upper case 4 can be minimized as compared with the conventional technique of uniformly increasing the thickness of the entire upper case 4. Therefore, it is possible to suppress an increase in the weight of the upper case 4 as compared with the conventional technique while improving the heat resistance. Further, especially in the upper case 4 arranged below the floor panel 8, it is possible to suppress an increase in the thickness of the inner peripheral portion 30 as compared with the outer peripheral portion 20. Here, since the amplitude of the inner peripheral portion 30 with respect to the vertical vibration during traveling is larger than the amplitude of the outer peripheral portion 20, the clearance between the floor panel 8 and the upper case 4 is set with reference to the inner peripheral portion 30. According to this configuration, the clearance between the floor panel 8 and the upper case 4 may be determined with reference to the inner peripheral portion 30 formed thinner than the outer peripheral portion 20. As a result, the clearance between the floor panel 8 and the upper case 4 can be set smaller compared to increasing the overall thickness including the inner peripheral portion 30. Similarly, the clearance between the upper case 4 and the batteries 2 can be set small. Therefore, especially when the batteries 2 and the upper case 4 are arranged below the floor panel 8, compared with the conventional technique of uniformly increasing the thickness, the height of the floor panel 8 can be lowered while improving the heat resistance. As a result, the vehicle compartment space can be expanded.

Therefore, it is possible to provide the battery case structure 1 having improved heat resistance while suppressing an increase in weight.

The upper case 4 is formed in a plate shape by a metal material, and the reinforcing member 25 is attached to the outer peripheral portion 20. By attaching the reinforcing member 25, the thickness of the outer peripheral portion 20 can be increased. Therefore, with a simple configuration, it is possible to make only the thickness t2 of the outer peripheral portion 20 thicker than the thickness t1 of the inner peripheral portion 30. Further, since the upper case 4 can be formed in a plate shape, the manufacturability of the upper case 4 can be improved.

The upper case 4 includes the upper flange 13 connected to the lower case 3, the horizontal plate portion 11 provided above the upper flange 13, and the upper inclined portion 15 connecting the upper flange 13 and the horizontal plate portion 11. The horizontal plate portion 11 is the upper surface portion. As a result, the heat resistance of the horizontal plate portion 11 of the upper case 4 located between the batteries 2 and the floor panel 8 can be effectively improved while suppressing the increase in weight. Therefore, the battery case structure 1 having high heat resistance can be obtained by a simple configuration.

### Second Embodiment

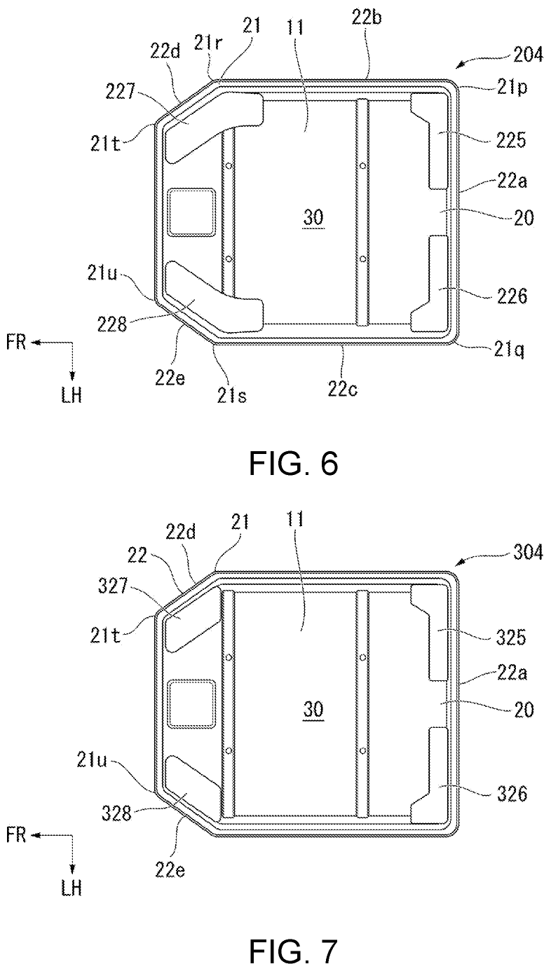

Next, a second embodiment according to the disclosure will be described. FIG. 6 is a plan view of an upper case 204 according to the second embodiment. In the following description, the same components as those of the first embodiment described above will be designated by the same reference numerals, and the description thereof will be appropriately omitted. The present embodiment is different from the first embodiment in that the reinforcing members 225, 226, 227, and 228 are attached to part of the outer peripheral portion 20.

In the second embodiment, of the outer peripheral portion 20 in the horizontal plate portion 11 of the upper case 204, the portions corresponding to the corner portions 21 are formed to be thicker than thicknesses of other portions of the horizontal plate portion 11. The portions of the outer peripheral portion 20 of the horizontal plate portion 11 corresponding to the corner portions 21 are formed to be thicker than the other portions by attaching the reinforcing members 225, 226, 227, and 228. In the second embodiment, four reinforcing members 225, 226, 227, 228 are provided. A first reinforcing member 225 is provided at a position corresponding to the first corner portion 21p. The first reinforcing member 225 extends from the first corner portion 21p to the right end portion of the first side 22a. A second reinforcing member 226 is provided at a position corresponding to the second corner portion 21q. The second reinforcing member 226 extends from the second corner portion 21q to the left end portion of the first side 22a. A third reinforcing member 227 is provided at a position corresponding to the third corner portion 21r and the fifth corner portion 21t. The third reinforcing member 227 extends from the fifth corner portion 21t through the fourth side 22d and the third corner portion 21r to the front end portion of the second side 22b. A fourth reinforcing member 228 is provided at a position corresponding to the fourth corner portion 21s and the sixth corner portion 21u. The fourth reinforcing member 228 extends from the sixth corner portion 21u through the fifth side 22e and the fourth corner portion 21s to the front end portion of the third side 22c.

According to the second embodiment, the upper case 204 is formed in a polygonal shape, and the thicknesses of the portions of the outer peripheral portion 20 corresponding to the corner portions 21 are thicker than the thickness of the other portions of the horizontal plate portion 11. By increasing the thicknesses of the corner portions 21 of the outer peripheral portion 20 where heat is particularly likely to concentrate, the heat resistance of the upper case 204 can be improved more effectively. Further, the area where the thickness is increased can be reduced as compared with the case where the thickness of the entire outer peripheral portion 20 is increased. Therefore, it is possible to further suppress the increase in weight while improving the heat resistance.

Further, the thickness of the shortest linear portion (the fourth side 22d and the fifth side 22e) having the shortest length among the plurality of linear portions (the sides 22) is the same as the thicknesses of the corner portions 21. As a result, it is possible to improve the heat resistance of the shortest linear portions 22d and 22e having short distances from the corner portions 21 and where heat tends to concentrate. Therefore, the heat resistance of the upper case 204 can be effectively improved by increasing the thickness of the shortest linear portions 22d and 22e in which heat is most likely to be concentrated among the linear portions 22.

### Third Embodiment

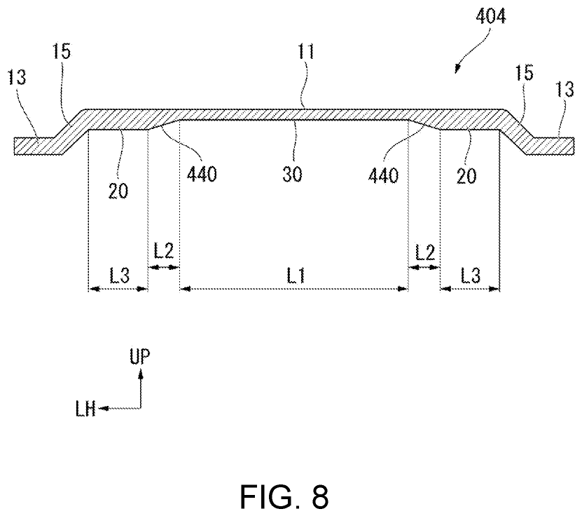

Next, a third embodiment according to the disclosure will be described. FIG. 7 is a plan view of an upper case 304 according to the third embodiment. In the following description, the same components as those of the first embodiment described above will be designated by the same reference numerals, and the description thereof will be appropriately omitted. In the present embodiment, the areas for attaching the reinforcing members 325, 326, 327, 328 are different from those in the second embodiment.

In the third embodiment, the horizontal plate portion 11 of the upper case 304 has a plurality of sides 22 (linear portions) located between the adjacent corner portions 21, and the thickness of the shortest linear portion (the fourth side 22d and the fifth side 22e) having the shortest length among the plurality of sides 22 is the same as the thicknesses of the corner portions 21. Of the outer peripheral portion 20 of the horizontal plate portion 11, the portions corresponding to the corner portions 21 and the shortest linear portions 22d and 22e are formed to be thicker than other portions by attaching the reinforcing members 325, 326, 327, and 328. In the third embodiment, four reinforcing members 325, 326, 327, 328 are provided. Since the configurations of a first reinforcing member 325 and a second reinforcing member 326 are the same as the configurations of the first reinforcing member 225 and the second reinforcing member 226 of the second embodiment, the description thereof is omitted here. A third reinforcing member 327 is provided at a position corresponding to the fifth corner portion 21t and the fourth side 22d (shortest linear portion). The third reinforcing member 327 extends from the fifth corner portion 21t over the entire fourth side 22d. A fourth reinforcing member 328 is provided at a position corresponding to the sixth corner portion 21u and the fifth side 22e (shortest linear portion). The fourth reinforcing member 328 extends from the sixth corner portion 21u over the entire fifth side 22e.

According to the third embodiment, the thicknesses of the shortest linear portions 22d and 22e having the shortest length among the plurality of linear portions (the sides 22) are the same as the thickness of the corner portions 21. As a result, it is possible to improve the heat resistance of the shortest linear portions 22d and 22e having short distances from the corner portions 21 and where heat tends to concentrate. In this way, the heat resistance of the upper case 304 can be effectively improved, in addition to the corner portions 21, by increasing the thicknesses of the shortest linear portions 22d and 22e in which heat is most likely to concentrate among the linear portions 22.

### Fourth Embodiment

Next, a fourth embodiment according to the disclosure will be described. FIG. 8 is a cross-sectional view of the upper case 404 according to the fourth embodiment. In the following description, the same components as those of the first embodiment described above will be designated by the same reference numerals, and the description thereof will be appropriately omitted. The present embodiment differs from the first embodiment in that the upper case 404 is made of a resin material.

In the fourth embodiment, the upper case 404 is formed in a plate shape, for example, by molding a resin material. As the material of the upper case 404, for example, polypropylene (PP) is desirable. The material of the upper case 404 may be any resin, and is not limited to polypropylene. As shown in FIG. 8, the horizontal plate portion 11 of the upper case 404 is formed by integrally molding the inner peripheral portion 30 and the outer peripheral portion 20 thicker than the inner peripheral portion 30. A plate thickness change portion 440 is provided between the inner peripheral portion 30 and the outer peripheral portion 20. In the plate thickness change portion 440, the thickness of the horizontal plate portion 11 gradually increases from the inner peripheral portion 30 to the outer peripheral portion 20. The outer peripheral portion 20 of the horizontal plate portion 11 is formed to be thicker than the inner peripheral portion 30 over the entire periphery. Further, the upper inclined portion 15 and the upper flange 13 of the upper case 404 have the same thickness as the outer peripheral portion 20. The lower case 3 (see FIG. 3) may also be made of a resin material, similar to the upper case 404.

According to the fourth embodiment, the upper case 404 is formed in a plate shape by a resin material, and the inner peripheral portion 30 and the outer peripheral portion 20 are integrally molded. As a result, when the upper case 404 is made of resin, it can be formed as one component in which the inner peripheral portion 30 and the outer peripheral portion 20 are combined. Therefore, the number of components can be reduced.

The technical scope of the disclosure is not limited to the above-described embodiment, and various modifications can be made without departing from the spirit of the disclosure.

Of the first embodiment described above, the structure in which the reinforcing member 25 is a metal patch has been described, but the disclosure is not limited thereto. The reinforcing member 25 may be, for example, an aluminum sheet or tape. The reinforcing member 25 may be formed of a metal material different from that of the upper case 4.

The portion of the horizontal plate portion 11 that where the thickness is increased, that is, the portion where the reinforcing member 25 is attached is not limited to the configuration of the above-described embodiment. At least any portion of the outer peripheral portion 20 may be formed to be thicker than the thickness of the inner peripheral portion 30, and the reinforcing member 25 may be attached at a position corresponding to any corner portion and side of the plurality of corner portions 21 and sides 22. However, when the reinforcing member 25 is provided in the portion corresponding to the side 22, the configuration of the present embodiment in which the reinforcing member 25 is provided at least in the shortest linear portions 22d and 22e is advantageous in that the heat resistance can be further improved.

In the fourth embodiment described above, the configuration in which the thick outer peripheral portion 20 and the thin inner peripheral portion 30 are integrally molded has been described, but the disclosure is not limited thereto. Similar to the first embodiment, the thickness of the outer peripheral portion 20 may be increased by attaching a resin reinforcing member to the outer peripheral portion 20. Further, although the configuration formed such that the thickness is increased over the entire periphery of the outer peripheral portion 20 of the horizontal plate portion 11, the disclosure is not limited thereto. Similar to the second embodiment, the third embodiment, and the like, the outer peripheral portion 20, it is possible to increase only the thicknesses of the portions corresponding to the corner portions 21 and the shortest linear portions 22d and 22e.

Further, the battery case structure according to the disclosure of technical solution 2 is characterized in that the upper case is formed in a plate shape by a metal material, and a plate-shaped reinforcing member (e.g. a reinforcing member 25 of the first embodiment) is attached to the outer peripheral portion.

Further, the battery case structure according to the disclosure of technical solution 3 is characterized in that the upper case (e.g. an upper case 404 in the fourth embodiment) is formed in a plate shape by a resin material, and the upper surface portion is formed by integrally molding the inner peripheral portion and the outer peripheral portion thicker than the inner peripheral portion.

Further, the battery case structure according to the disclosure of technical solution 4 is characterized in that the upper case is formed in a polygonal shape having a plurality of corner portions (e.g. corner portions 21 of the first embodiment) in a plan view, and thicknesses of portions of the outer peripheral portion of the upper surface portion corresponding to the corner portions are thicker than thicknesses of other portions of the upper surface portion.

Further, the battery case structure according to the disclosure of technical solution 5 is characterized in that the upper surface portion has a plurality of linear portions (e.g. sides 22 of the first embodiment) located between the adjacent corner portions, and a thickness of the shortest linear portion (e.g. a fourth side 22d and a fifth side 22e of the first embodiment) having a shortest length among the plurality of linear portions is equal to a thickness of the corner portions.

Further, the battery case structure according to the disclosure of technical solution 6 is characterized in that the upper case includes a flange (e.g. an upper flange 13 of the first embodiment) that comes into contact with the lower case and is connected to the lower case, a horizontal plate portion (e.g. the horizontal plate portion 11 of the first embodiment) provided above the flange, and an inclined portion that connects the flange and the horizontal plate portion (e.g. an upper inclined portion 15 of the first embodiment), in which the horizontal plate portion is the upper surface portion.

### Effects

According to the battery case structure according to technical solution 1 of the disclosure, the upper case is provided between the battery and the floor panel. The thickness of the outer peripheral portion of the upper case is thicker than the thickness of the inner peripheral portion. As a result, the heat resistance of the outer peripheral portion, which tends to be higher than that of the inner peripheral portion, is enhanced. As a result, the overall heat resistance of the upper case can be improved while keeping the thickness of the inner peripheral portion thin. Since the heat resistance of the upper case can be improved by increasing only the thickness of the outer peripheral portion, the weight increase of the upper case can be minimized as compared with the conventional technique of uniformly increasing the thickness of the entire upper case. Therefore, it is possible to suppress the weight increase the upper case as compared with the conventional technique while improving the heat resistance. Moreover, especially in the upper case arranged below the floor panel, it is possible to suppress an increase in the thickness of the inner peripheral portion as compared with the outer peripheral portion. Here, since an amplitude of the inner peripheral portion with respect to the vertical vibration during traveling is larger than an amplitude of the outer peripheral portion, a clearance between the floor panel and the upper case is set with reference to the inner peripheral portion. According to this configuration, the clearance between the floor panel and the upper case can be determined with reference to the inner peripheral portion formed thinner than the outer peripheral portion. As a result, the clearance between the floor panel and the upper case can be set smaller compared to increasing the overall thickness including the inner peripheral portion. Similarly, the clearance between the upper case and the battery can be set small. Therefore, especially when the battery and the upper case are arranged below the floor panel, compared with the conventional technique of uniformly increasing the thickness, the height of the floor panel can be lowered while improving the heat resistance. As a result, the vehicle compartment space can be expanded.

Therefore, it is possible to provide a battery case structure having improved heat resistance while suppressing an increase in weight.

According to the battery case structure according to technical solution 2 of the disclosure, the upper case is formed in a plate shape by a metal material, and a reinforcing member is attached to the outer peripheral portion. By attaching a reinforcing member, the thickness of the outer peripheral portion can be increased. Therefore, with a simple configuration, it is possible to make only the thickness of the outer peripheral portion thicker than the thickness of the inner peripheral portion. Further, since the upper case may be formed in a plate shape, the manufacturability of the upper case can be improved.

According to the battery case structure according to technical solution 3 of the disclosure, the upper case is formed in a plate shape by a resin material, and the inner peripheral portion and the outer peripheral portion are integrally molded. As a result, when the upper case is made of resin, it can be formed as one component in which the inner peripheral portion and the outer peripheral portion are combined. Therefore, the number of components can be reduced.

According to the battery case structure according to technical solution 4 of the disclosure, the upper case is formed in a polygonal shape, and thicknesses of the portions of the outer peripheral portion corresponding to corner portions are thicker than thicknesses of other portions of the upper surface portion. By increasing the thicknesses of the corner portions of the outer peripheral portion where heat is particularly likely to concentrate, the heat resistance of the upper case can be improved more effectively. Further, the area where the thickness is increased can be reduced as compared with the case where the thickness of the entire outer peripheral portion is increased. Therefore, it is possible to further suppress the increase in weight while improving the heat resistance.

According to the battery case structure according to technical solution 5 of the disclosure, a thickness of a shortest linear portion having a shortest length among the plurality of linear portions is the same as thicknesses of the corner portions. As a result, it is possible to improve the heat resistance in the shortest linear portion having short distances to the corner portions and where heat tends to concentrate. As described above, the heat resistance of the upper case can be effectively improved, in addition to the corner portion, by increasing the thickness of the shortest linear portion in which heat is most likely to concentrate among the linear portions.

According to the battery case structure according to technical solution 6 of the disclosure, the upper case includes a flange that is connected to the lower case, a horizontal plate portion provided above the flange, and an inclined portion that connects the flange and the horizontal plate portion. The horizontal plate portion is the upper surface portion. As a result, in the upper case, in the horizontal plate portion located between the battery and the floor panel, the heat resistance can be effectively improved while suppressing the increase in weight. Therefore, a battery case structure having high heat resistance can be obtained by a simple configuration.

In addition, it is possible to replace the components in the above-described embodiments with well-known components as appropriate without departing from the spirit of the disclosure, and the above-described embodiments may be combined as appropriate.

What is claimed is:

1. A battery case structure, comprising:
a battery provided below a floor panel of a vehicle,
a lower case covering the battery from below, and
an upper case having an upper surface portion arranged between the floor panel and the battery and covering the battery from above,
wherein a thickness of an outer peripheral portion of the upper surface portion of the upper case along the vertical direction is thicker than a thickness of an inner peripheral portion of the upper surface portion along the vertical direction.

2. The battery case structure according to claim 1, wherein
the upper case is formed in a plate shape by a metal material, and
a plate-shaped reinforcing member is attached to the outer peripheral portion.

3. The battery case structure according to claim 1, wherein
the upper case is formed in a plate shape by a resin material, and
the upper surface portion is formed by integrally molding the inner peripheral portion and the outer peripheral portion thicker than the inner peripheral portion.

4. The battery case structure aspect according to claim 1, wherein
the upper case is formed in a polygonal shape having a plurality of corner portions in a plan view, and
thicknesses of portions of the outer peripheral portion of the upper surface portion corresponding to the corner portions are thicker than thicknesses of other portions of the upper surface portion.

5. The battery case structure aspect according to claim 2, wherein
the upper case is formed in a polygonal shape having a plurality of corner portions in a plan view, and
thicknesses of portions of the outer peripheral portion of the upper surface portion corresponding to the corner portions are thicker than thicknesses of other portions of the upper surface portion.

6. The battery case structure aspect according to claim 3, wherein
the upper case is formed in a polygonal shape having a plurality of corner portions in a plan view, and
thicknesses of portions of the outer peripheral portion of the upper surface portion corresponding to the corner portions are thicker than thicknesses of other portions of the upper surface portion.

7. The battery case structure according to claim 4, wherein
the upper surface portion has a plurality of linear portions located between the adjacent corner portions, and
a thickness of a shortest linear portion having a shortest length among the plurality of linear portions is equal to thicknesses of the corner portions.

8. The battery case structure according to claim 5, wherein
the upper surface portion has a plurality of linear portions located between the adjacent corner portions, and
a thickness of a shortest linear portion having a shortest length among the plurality of linear portions is equal to thicknesses of the corner portions.

9. The battery case structure according to claim 6, wherein
the upper surface portion has a plurality of linear portions located between the adjacent corner portions, and
a thickness of a shortest linear portion having a shortest length among the plurality of linear portions is equal to thicknesses of the corner portions.

10. The battery case structure according to claim 1, wherein
the upper case comprises:
a flange that comes into contact with the lower case and is connected to the lower case,
a horizontal plate portion provided above the flange, and
an inclined portion that connects the flange and the horizontal plate portion, wherein
the horizontal plate portion is the upper surface portion.

11. The battery case structure according to claim 2, wherein
the upper case comprises:
a flange that comes into contact with the lower case and is connected to the lower case,
a horizontal plate portion provided above the flange, and
an inclined portion that connects the flange and the horizontal plate portion, wherein
the horizontal plate portion is the upper surface portion.

12. The battery case structure according to claim 3, wherein
the upper case comprises:
a flange that comes into contact with the lower case and is connected to the lower case,
a horizontal plate portion provided above the flange, and
an inclined portion that connects the flange and the horizontal plate portion, wherein
the horizontal plate portion is the upper surface portion.
